(19) United States
(12) Patent Application Publication
(10) Pub. No.: US 2010/0275164 A1
(43) Pub. Date: Oct. 28, 2010

(54) AUTHORING APPARATUS

(75) Inventor: Goichi Morikawa, Fussa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/697,102

(22) Filed: Jan. 29, 2010

(30) Foreign Application Priority Data
Apr. 22, 2009 (JP) 2009-104324

(51) Int. Cl. G06F 3/048

(52) U.S. Cl. 715/838

(57) ABSTRACT

An authoring apparatus includes: a storage module configured to store a plurality of face images while being correlated with time stamp information pieces; a display processing module configured to process the face images; a chapter generating module configured to generate chapter information for setting a chapter in the video data based on a selected time stamp information piece when one of the face images being displayed as the list is selected as a selected face image; a menu screen data generating module configured to generate menu screen data to be used for displaying a menu screen in which the selected face image is used as a button to jump to the chapter where the selected face image appears; and a converting module configured to generate converted data to be written on an optical disc, the converted data including the video data and the menu screen data.

### CROSS REFERENCE TO RELATED APPLICATION(S)

The present disclosure relates to the subject matters contained in Japanese Patent Application No. 2009-104324 filed on Apr. 22, 2009, which are incorporated herein by reference in its entirety.

### FIELD

The present invention relates to an authoring apparatus, method, and program for generating data to be stored in an optical disc from video data.

### BACKGROUND

Chapters may be added at arbitrary positions of video content data to be stored in a recording medium such as an optical disc. And a jump to a desired position of the video content data can be made by selecting one of the chapters thus added. Such chapters are added in editing video content data, however, adding chapters is a relatively complicated procedure. In view of this, JP-A-2004-274171, for example, discloses a technique of an authoring application for adding a chapter automatically for every given time interval.

Although the authoring application described in JP-A-2004-274171 of Patent document 1 is advantageous in that chapters are automatically added, the automatic addition of chapters at given time intervals raises a problem that a scene a user may want to view does not always appear immediately after a chapter jump.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view showing an appearance of an authoring apparatus according to an embodiment of the present invention.

FIG. 2 is a block diagram showing an example system configuration of the authoring apparatus according to the embodiment.

FIG. 3 is a block diagram showing a video indexing function of the authoring apparatus according to the embodiment.

FIG. 4 shows the concept of authoring processing according to the embodiment.

FIG. 5 is a block diagram showing the configuration of an authoring application program according to the embodiment.

FIG. 6 shows an example screen that is displayed in authoring video content data.

FIG. 7 shows an example menu screen.

FIG. 8 shows an example video content data acquiring screen.

FIG. 9 shows the concept of chapter information.

FIG. 10 is a flowchart showing a procedure for generating video content data having the DVD-Video format.

### DETAILED DESCRIPTION OF THE EMBODIMENTS

An embodiment of the present invention will be hereinafter described with reference to the drawings.

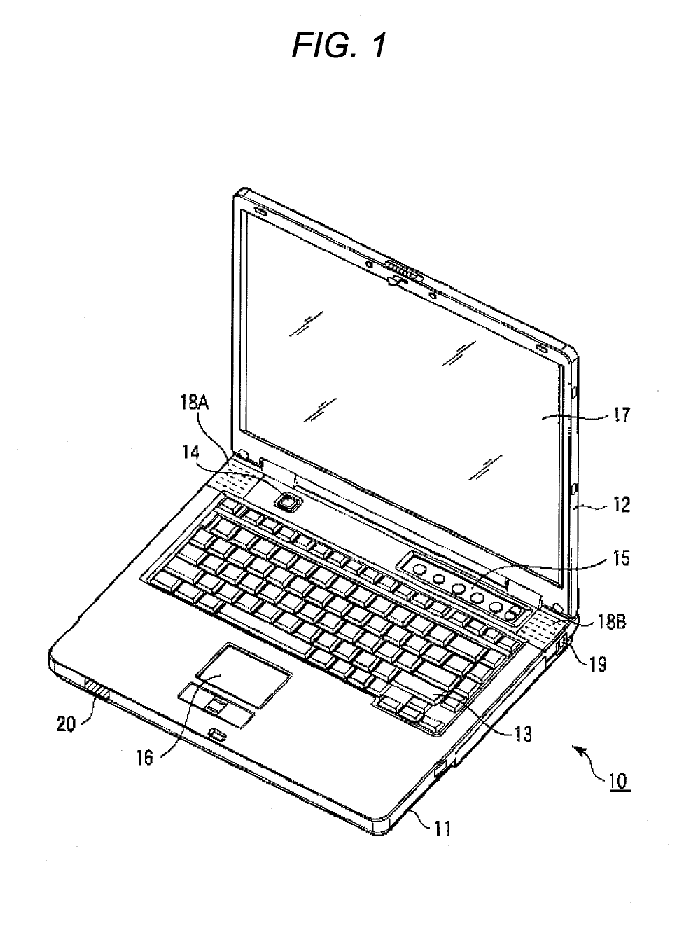

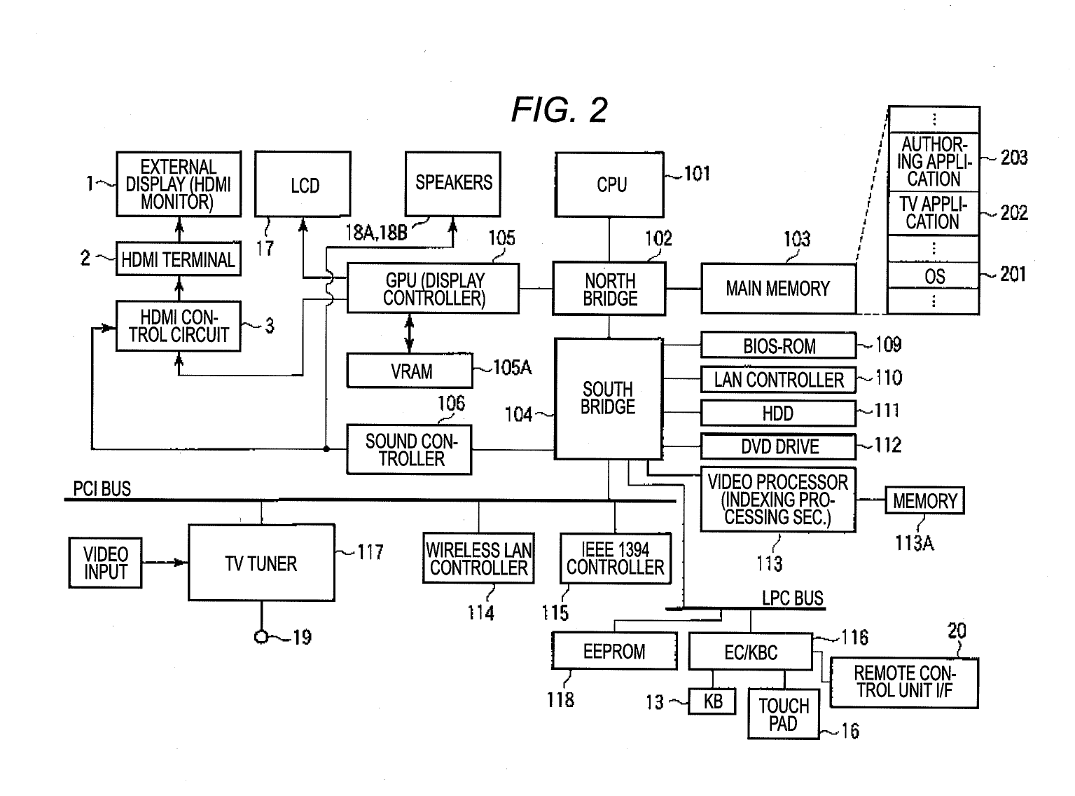

A configuration of an electronic apparatus according to the embodiment of the invention will be described with reference to FIGS. 1 and 2. The electronic apparatus according to the embodiment is a portable notebook personal computer 10 which serves as an information processing apparatus.

The personal computer 10 is capable to record, edit, and reproduce video content data (AV (audio/visual) content data) such as broadcast program data and video data that is input from an external AV apparatus. For example, the personal computer 10 has a television (TV) function of displaying (with audio generation), recording, editing, and reproducing broadcast program data which is broadcast in the form of a TV broadcast signal. For example, the TV function is realized by a TV application program which is preinstalled in the personal computer 10. The TV function is also provided with a function of recording video data that is input from an external AV apparatus and a function of editing and reproducing recorded video data or recorded broadcast program data.

The personal computer 10 is also provided with a face image list display function of detecting face images of human faces appearing in video content data such as video data or broadcast program data stored in the personal computer 10 (face image indexing function (video analyzing function); described later) and displaying a list, for example, of the detected face images. The face image list display function is incorporated in the TV function as one of its functions. The face image list display function is one of video indexing functions for presenting a summary or the like of video content data to the user. The face image list display function presents, to the user, information indicating what persons appear in what time slots in the entire video content data. Furthermore, an authoring function of the computer 10 stores, as pieces of chapter information, scenes corresponding to face images selected by the user from face images that are displayed in list form and can store, in a recording medium such as an optical disc, video content data to which chapters have been added using the pieces of chapter information. The face image list display function is also provided with a grouping function of analyzing moving image data (video content data) and registering face images of the same person as a group.

FIG. 1 is a perspective view of the computer 10 in a state that a display unit 12 is opened. The computer 10 is composed of a main unit 11 and the display unit 12. The display unit 12 incorporates a display device which is a TFT-LCD (thin-film transistor liquid crystal display) 17.

The display unit 12 is added to the main unit 11 so as to be rotatable between an open position where it exposes the top face of the main unit 11 and a closed position where it covers the top face of the main unit 11. The main unit 11 has a thin, box-shaped body. A keyboard 13, a power button 14 for powering on/off the computer 10, an operation panel 15, a touch pad 16, speakers 18A and 18B, etc. are provided on the top face of the main unit 11.

The operation panel 15, which is an input device through which to input an event corresponding to a pressed button, is provided with plural buttons for activating plural respective functions. The buttons include buttons for controlling the TV function (display (with audio generation), recording, and reproduction of recorded broadcast program data or video data). The front face of the main unit 11 is provided with a remote control unit interface unit 20 for communicating with a remote control unit which is used for remotely controlling the TV function etc. of the computer 10. The remote control unit interface unit 20 is an infrared signal receiving unit, for example.

The right-hand side face, for example, of the main unit 11 is provided with an antenna terminal 19 for TV broadcast. The back face, for example, of the main unit 11 is provided with an external display connection terminal that complies with the HDMI (high-definition multimedia interface) standard, for example. This external display connection terminal is used for outputting video data (moving image data) included in video content data such as broadcast program data to an external display.

Next, the system configuration of the computer 10 will be described with reference to FIG. 2.

As shown in FIG. 2, the computer 10 is equipped with a CPU 101, a northbridge 102, a main memory 103, a southbridge 104, a graphics processing unit (GPU) 105, a video memory (VRAM) 105A, a sound controller 106, a BIOS-ROM 109, a LAN controller 110, a hard disk drive (HDD) 111, a DVD drive 112, a video processor 113, a memory 113A, a wireless LAN controller 114, an IEEE 1394 controller 115, an embedded controller/keyboard controller IC (EC/KBC) 116, a TV tuner 117, an EEPROM 118, etc.

The DVD drive 112 is an optical disc drive capable of writing various data such as video content data that has been subjected to authoring.

The CPU 101, which is a processor for controlling the operations of the computer 10, runs various kinds of application programs that are loaded into the main memory 103 from the HDD 111, such as an operating system (OS) 201, a TV application program (also called “TV application”) 202, and an authoring application program (also called “authoring application”) 203. The TV application program 202 is software for performing the TV function. The authoring application program 203 is software for performing processing of converting video content data stored in the HDD 11, for example, into data having a format of a recording medium such as an optical disc, processing of writing the converted video content data to the recording medium, and other processing.

The TV application program 202 performs live reproduction processing for displaying (with audio generation) broadcast program data received by the TV tuner 117, recording processing of recording received broadcast program data in the HDD 111, reproduction processing of reproducing broadcast program data or video data recorded in the HDD 111, and other processing. The authoring application program 203 serves to complete a recording medium having a prescribed format such as an optical disc (e.g., a DVD having the DVD-Video format) based on video content data stored in the HDD 111. To this end, the authoring application program 203 performs processing of editing the video content data, processing of generating menu screen data (including chapter addition processing), processing of converting the video content data and the menu screen data into data having the DVD-Video format, writing the converted data to the recording medium such as an optical disc (e.g., DVD-R disc).

The CPU 101 also runs a BIOS (basic input/output system) which is stored in the BIOS-ROM 109. The BIOS is a program for hardware control.

The northbridge 102 is a bridge device which connects a local bus of the CPU 101 and the southbridge 104. The northbridge 102 incorporates a memory controller for access-controlling the main memory 103. The northbridge 102 also has a function of communicating with the GPU 105 via a serial bus that complies with the PCI Express standard.

The GPU 105 is a display controller for controlling the LCD 17 which is used as a display monitor of the computer 10. A display signal generated by the CPU 105 is sent to the LCD 17. The GPU 105 can also send a digital video signal to an external display device 1 via an HDMI control circuit 3 and an HDMI terminal 2.

The HDMI terminal 2 is the above-mentioned external display connection terminal. The HDMI terminal 2 allows to send a non-compressed digital video signal and a digital audio signal to the external display device 1 such as a TV receiver via a single cable. The HDMI control circuit 3 is an interface through which to send a digital video signal to the external display device 1 (called an HDMI monitor) via the HDMI terminal 2.

The southbridge 104 controls individual devices on an LPC (low pin count) bus and individual devices on a PCI (peripheral component interconnect) bus. The southbridge 104 incorporates an IDE (integrated drive electronics) controller for controlling the HDD 111 and the DVD drive 112. The southbridge 104 also has a function of communicating with the sound controller 106.

The video processor 113 is also connected to the southbridge 104 via, for example, a serial bus that complies with the PCI Express standard.

The video processor 113 is a processor for performing various kinds of processing that relate to the above-mentioned video indexing. The video processor 113 functions as an indexing processing section for performing video indexing (video analysis) processing. That is, in the video indexing processing, the video processor 113 extracts plural face images from moving image data that is included in video content data and outputs pieces of time stamp information that indicate time points when the extracted face images appear in the video content data, respectively, and other information. For example, face images are extracted by face detection processing of detecting a face region from each frame of moving image data, processing of cutting out the detected face regions from the frames, and other processing. For example, a face region can be detected by analyzing features of the image of each frame and finding a region having features that are similar to a face image feature sample that is prepared in advance. The face image feature sample is feature data obtained by statistically processing face image features of each of many persons.

The memory 113A is used as a work memory of the video processor 113. A large calculation amount is necessary for video indexing processing. In the embodiment, video indexing processing is performed by the video processor 113 which is used as a back end processor. The video processor 113 is separate from the CPU 101 and is dedicated to the video indexing. Therefore, video indexing processing can be performed without increasing the load on the CPU 101.

The sound controller 106, which is a sound source device, outputs reproduction subject audio data to the speakers 18A and 14B or the HDMI control circuit 3.

The wireless LAN controller 114 is a wireless communication device which performs a wireless communication that complies with the IEEE 802.11 standard, for example. The IEEE 1394 controller 115 communicates with an external apparatus via a serial bus that complies with the IEEE 1394 standard.

The embedded controller/keyboard controller IC (EC/KB) 116 is a one-chip microcomputer in which an embedded controller for power management and a keyboard controller for controlling the keyboard (KB) 13 and the touch pad 16 are integrated together. The EC/KBC 116 has a function of powering on/off the computer 10 in response to an operation on the power button 14 by the user. The EC/KBC 116 also has a function of communicating with the remote control unit interface unit 20.

The TV tuner 117, which is a receiving device for receiving broadcast program data that is broadcast in the form of a TV broadcast signal, is connected to the antenna terminal 19. For example, the TV tuner 117 is implemented as a digital TV tuner capable of receiving digital broadcast program data of a ground-wave digital TV broadcast. The TV tuner 117 also has a function of capturing video data that is input from an external apparatus.

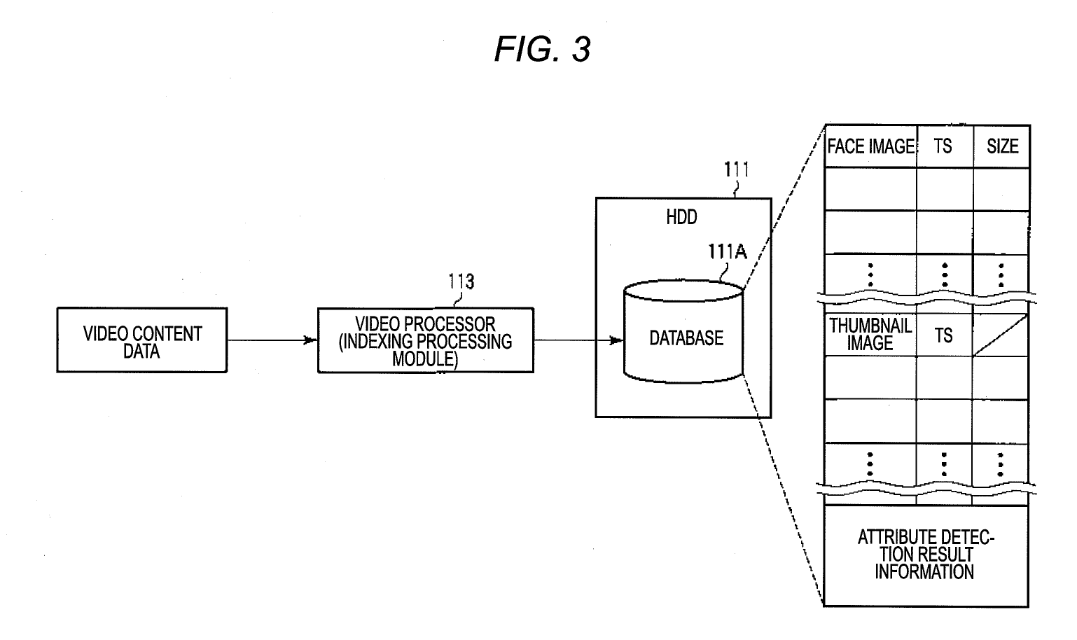

Next, the video indexing which is performed by the video processor 113 will be described with reference to FIG. 3.

As described above, video indexing processing on video content data such as broadcast program data is performed by the video processor 113.

The video processor 113 performs indexing processing on video content data such as recorded broadcast program data that has been specified by the user, under the control of the TV application program 202 or the authoring application program 203. The video processor 113 can also perform indexing processing on broadcast program data received by the TV tuner 117 in parallel with recording processing of recording the same broadcast program data in the HDD 111.

In the video indexing processing (also called face image indexing processing), the video processor 113 analyzes moving image data that is included in video content data on a frame-by-frame basis. Then, the video processor 113 extracts a face image of a person from each of plural frames constituting the moving image data and outputs pieces of time stamp information which indicate time points when the respective extracted face images appear in the video content data. Time stamp information corresponding to each face image may be an elapsed time from the head of the video content data to the appearance of the face image concerned, a frame number of a frame from which the face image has been extracted, or the like.

The video processor 113 also outputs a size (resolution) of each extracted face image. Face detection result data (face images, pieces of time stamp information TS, and sizes) that is output from the video processor 113 is stored in a database 111A as face image indexing information. The database 111A is a storage area for indexing data storage which is prepared in the HDD 111.

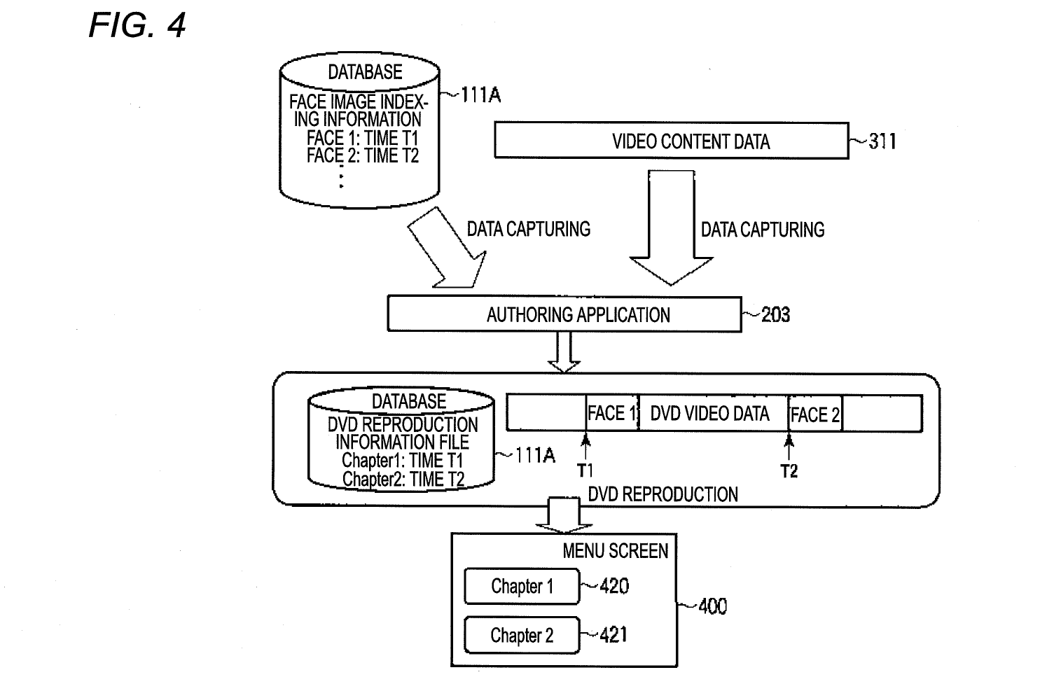

Next, an overview of the authoring according to the embodiment of the invention will be described with reference to FIG. 4.

Video content data 311 is stored in the HDD 111 of the computer 10 (it was stored by the TV application program 202). Face image indexing information obtained from the video content data 311 by video indexing processing is also stored in the database 111A. These data are captured into the authoring application program 203.

The authoring application program 203 list-displays the captured face image indexing information, and sets, as pieces of time stamp information of chapter positions, pieces of time stamp information (e.g., elapsed times (T1 and T2, for example) from a start time of the video content data 311) that correspond to pieces of face image indexing information selected by the user. The authoring application program 203 generates menu screen data by setting T1 and T2 or Chapter1 (420) and Chapter2 (421), respectively. The authoring application program 203 generates a menu screen 400 based on the menu screen data and writes it to a recording medium such as an optical disc.

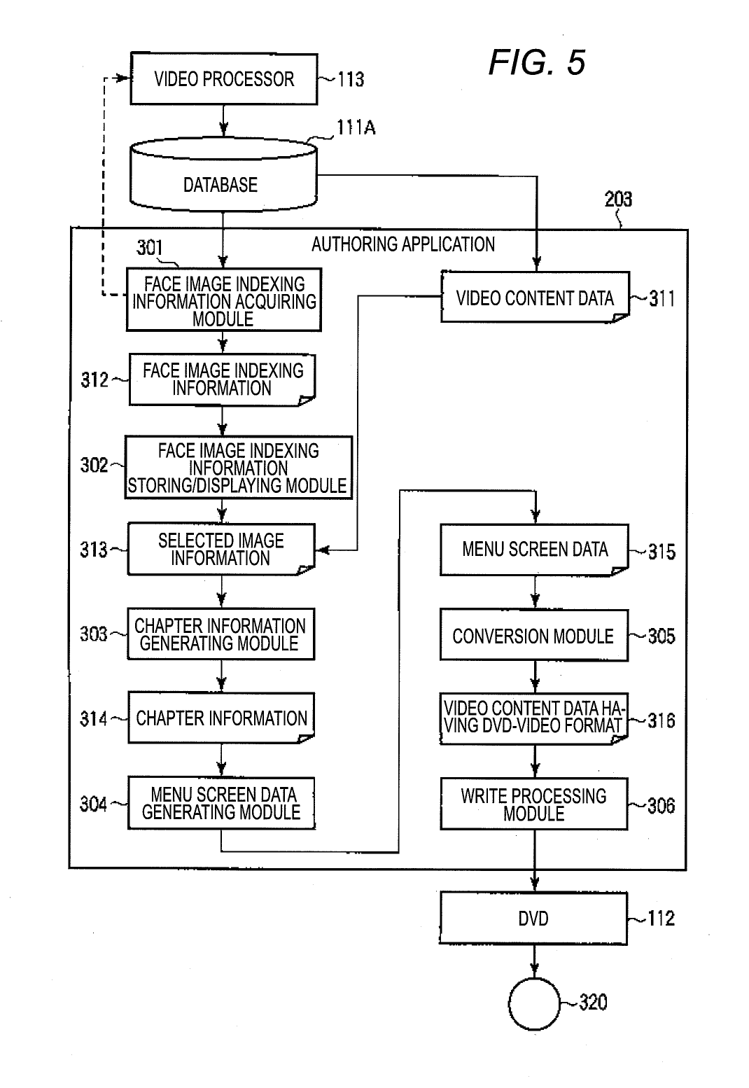

Next, the authoring process performed by the authoring application program 203 will be described with reference to FIG. 5.

The authoring application program 203 is provided with a face image indexing information acquiring module 301, a face image indexing information storing/displaying module (storage module and display processing module) 302, a chapter information generating module (chapter generating module) 303, a menu screen data generating module (menu screen data generating module) 304, a conversion module (module for generating data to be written to an optical disc) 305, and a write processing module 306.

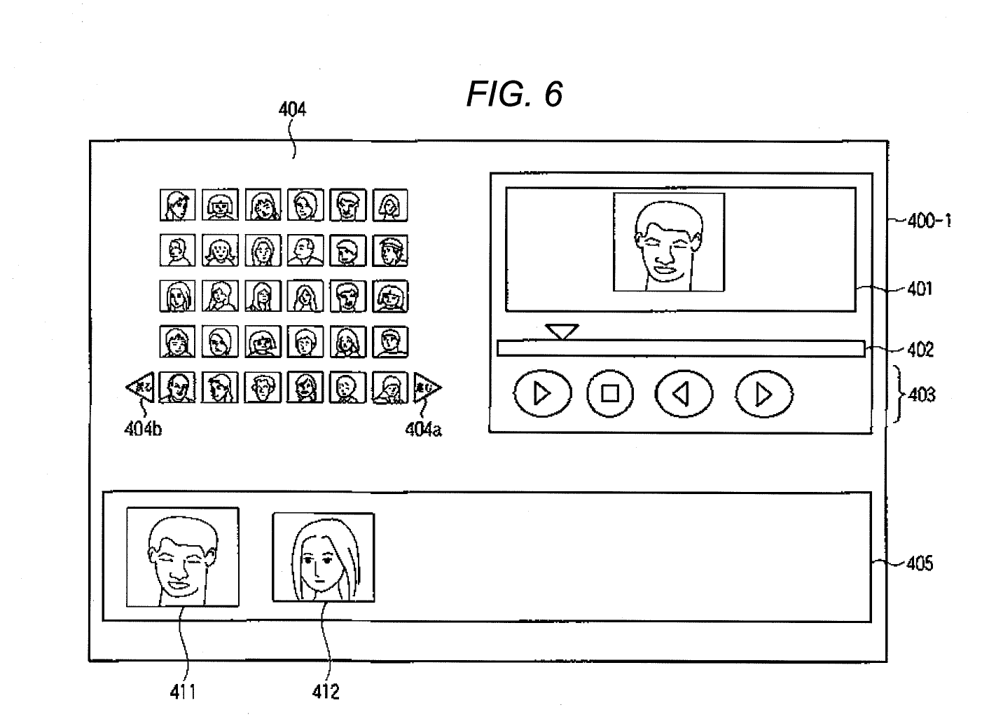

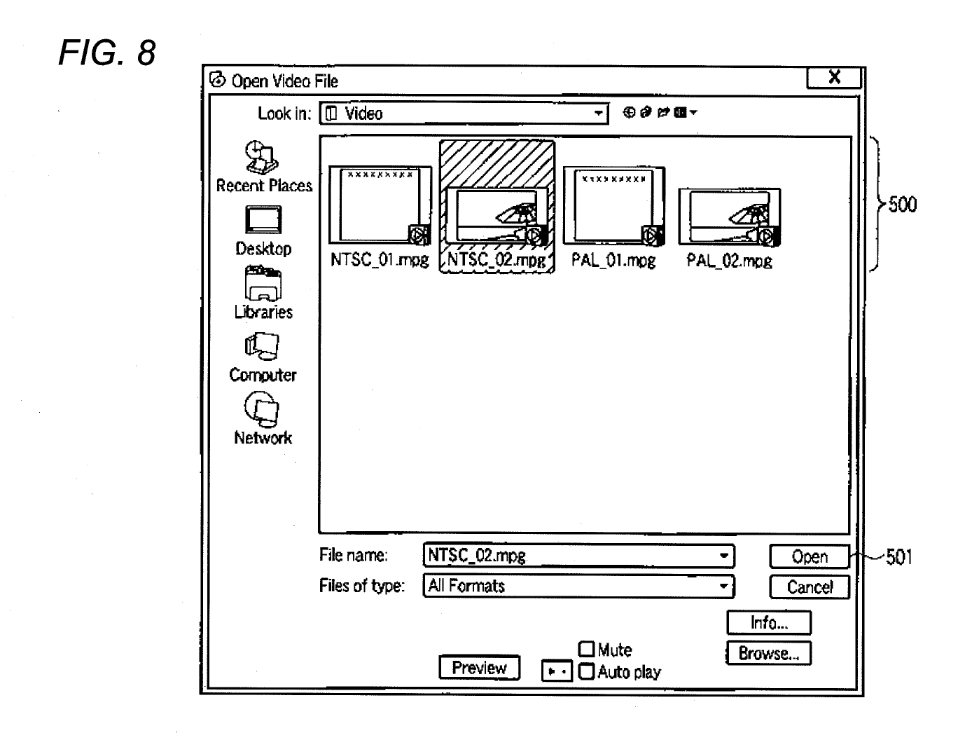

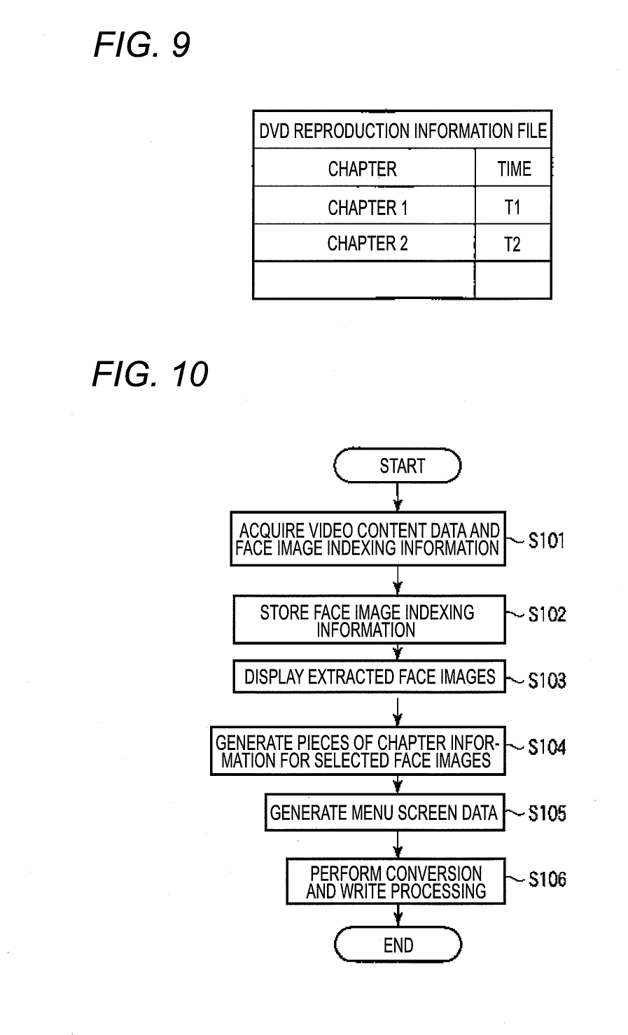

First, video content data 311 to be acquired is selected by the user (see FIG. 8) and acquired from the database 111A. At the same time, the face image indexing information acquiring module 301 acquires face image indexing information (face images, pieces of time stamp information, etc.) from the database 111A. After storing the acquired face image indexing information 312 in the database 111A, the face image indexing information acquiring module 301 displays it on the display screen in, for example, a manner shown in FIG. 6. A selected image display area 405, a video display area 401, a play control bar 402, and play control buttons 403 are displayed in an authoring display screen 400-1 of the authoring application 203. Face images 404 that were extracted by video indexing processing are displayed in the authoring display screen 400-1, and face images 411 and 412 that have been selected by the user are displayed in the selected image display area 405. For example, the face image selection by the user is performed by using a mouse. The face images 411 and 412 that have been selected by the user are stored as pieces of chapter information that are correlated with respective pieces of time stamp information in, for example, a manner shown in FIG. 9. In this case, the extracted face images 404 are list-displayed in time-series order based on their pieces of time stamp information. (Part of) the extracted face images 404 the number of which is within a preset, maximum displayable number are list-displayed. This allows to accommodate a case that the number of extracted face images 404 is enormous. Face images 404 that are not displayed currently can be displayed by scrolling the face images 404 using scroll buttons 404a and 404b. A desired one of the face images 411 and 412 selected by the user can be displayed in the video display area 401 by selecting it with the mouse. In this case, a scene including the selected desired face image can be reproduced by using the play control bar 402 and the play control buttons 403.

The authoring application 203 is provided with a grouping module for grouping the extracted face images 404 by determining face images 404 of each same person. The extracted face images 404 can be list-displayed on a group-by-group basis, that is, in such a manner that groups each of which includes face images 404 of the same person determined by the grouping module are arranged in order. For example, whether face images 404 are of the same person is judged by a procedure that a database of persons is stored in advance and each extracted face image 404 is compared with the database.

The face images 411 and 412 selected by the user are captured into the authoring application 203 and are made selected image information 313. At the same time, the video content data 311 is acquired from the database 111A. The face images 411 and 412 selected by the user are correlated with respective pieces of time stamp information or the like. The video content data 311 is acquired by selecting a storage place such as the HDD 111 of the computer 10 or a network in, for example, a manner shown in FIG. 8, and displayed in the display area 500. The video content data 311 is selected by the mouse, for example, and acquired by pressing a file opening button such as an “Open” button 501.

The chapter information generating module 303 generates pieces of chapter information based on the pieces of time stamp information that are correlated with the selected face images 411 and 412. For example, pieces of chapter information are generated as shown in FIG. 9.

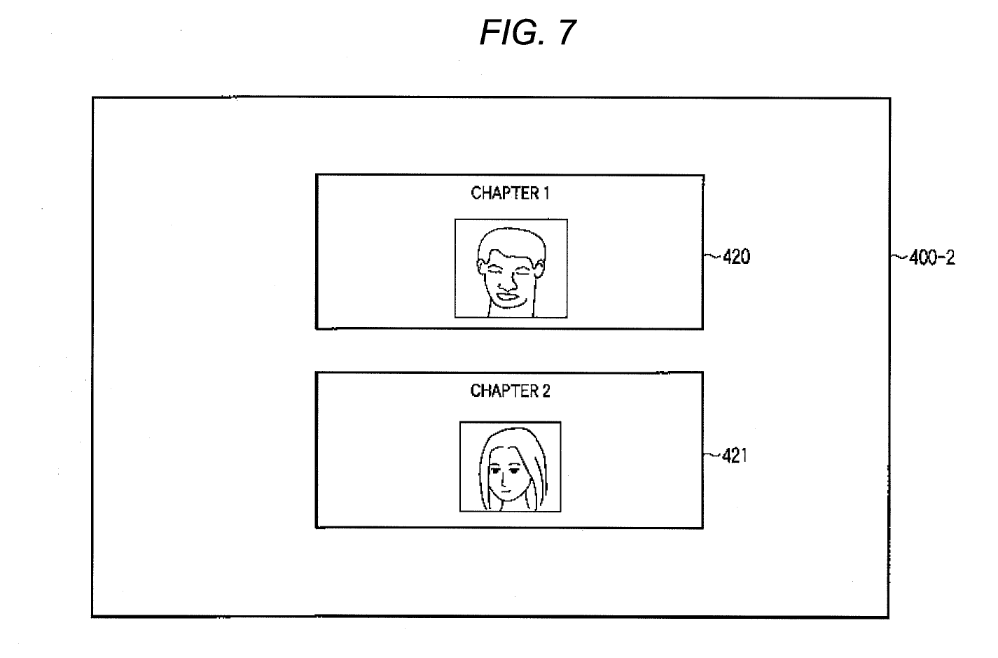

The menu screen data generating module 304 generates menu screen data 315 based on the pieces of chapter information and generates a menu screen 400-2 in, for example, a manner shown in FIG. 7. For example, menu screen data 315 is generated by setting T1 and T2 for Chapter1 (420) and Chapter2 (421), respectively.

The menu screen 400-2 is a menu that is displayed first when DVD-Video data, for example, is reproduced. The menu screen 400-2 may be one page or plural pages. The menu screen data 315 can be generated so that face images existing in a set period including the time point indicated by time stamp information will be read from the database 111A and displayed in the form of a slide show. Likewise, the menu screen data 315 may be generated so that face images existing in a prescribed chapter will be read out from the database 111A and displayed in the form of a slide show. Furthermore, the menu screen data 315 of a prescribed chapter may be generated so that that part of the video content data 311 which is located in the chapter is extracted and displayed in the form of a moving image.

The conversion module 305 generates data (post-authoring video content data 316) to be written to an optical disc 320 that includes the video content data 311 and the menu screen data 315 which has been generated by the menu screen data generating module 304 and based on which to display a menu screen on the display screen (of the LCD 17, for example). For example, the conversion module 305 converts the video content data 311 into the post-authoring video content data 316 having the DVD-Video format based on the menu screen data 315 and the selected image information 313 and outputs the post-authoring video content data 316. The video content data 316 having the DVD-Video format includes menu screen data 315 and information that enables a chapter jump in response to an operation on a jump button to be displayed in a menu screen.

The write processing module 306 writes the video content data 316 to the writable optical disc 320, for example, using the DVD drive 112 and thereby complete the optical disc 320.

When the thus-completed optical disc 320 is reproduced, jump buttons for jumps to chapter 1 and chapter 2, respectively, are displayed in the menu screen 400-2 (see FIG. 7). When the user clicks on “Chapter1” (420) in the menu screen 400-2, reproduction is started from the scene that is set as chapter 1. Likewise, if the user clicks on “Chapter2” (420) in the menu screen 400-2, reproduction is started from the scene that is set as chapter 2. Where, for example, the number of chapters is large, a “forward” button, a “return” button, etc. are displayed in the menu screen 400-2 and chapters that are not displayed currently can be displayed by switching display pages by scrolling.

Next, a procedure of a process that is executed by the authoring application program 203 will be described with reference to a flowchart of FIG. 10.

The user activates the authoring application program 203. Video content data 311 to be acquired is selected by the user (see FIG. 8), and the video content data 311 is acquired from the database 111A. Then, the face image indexing information acquiring module 301 acquires face image indexing information (face images, pieces of time stamp information, etc.) 312 from the database 111A (step S101). At step S102, the face image indexing information storing/displaying module 302 stores the acquired face image indexing information 312 in the database 111A. At step S103, the authoring application 203 displays, on the display screen (of the LCD 17, for example), face images that were extracted by video indexing processing.

At step S104, when one of the displayed face images is selected by the user, the chapter information generating module 303 generates chapter information based on the time stamp information that is correlated with the selected face image. At step S105, the menu screen data generating module 304 generates menu screen data based on the generated pieces of chapter information. The conversion module 305 generates data (post-authoring video content data) to be written to an optical disc 320 that includes the video content data 311 and the menu screen data 315 which has been generated by the menu screen data generating module 304 and based on which to display a menu screen on the display screen (of the LCD 17, for example). Then, the conversion module 305 converts the generated video content data into video content data 316 having the DVD-Video format based on the menu screen data 315 and the selected image information 313 and outputs it. The write processing module 306 writes the video content data 316 to the writable optical disc 320, for example, using the DVD drive 112 and thereby complete the optical disc 320 (step S106).

According to the process described above, when the user merely selects displayed face images, a menu screen having chapter buttons which is such that the selected face images of persons are pasted to video content data can be displayed. DVD-Video data for display of such a menu screen can be generated easily.

Although DVD-Video data is generated in the above embodiment, the invention can be implemented with various recording media such as optical discs. It is possible to generate data having the Blu-ray video format and write the generated data to a Blu-ray disc. The above-described program is stored in a computer-readable storage medium such as an HDD, a flash memory, or an optical disc.

Although the embodiment according to the present invention has been described above, the present invention is not limited to the above-mentioned embodiment but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An authoring apparatus configured to generate data to be stored in an optical disc from video data, the apparatus comprising:
a storage module configured to store a plurality of face images extracted from the video data while the face images are being correlated with time stamp information indicating the times when the face images appear in the video data;
a list display processor configured to generate a list comprising the face images to be displayed;
a chapter generator configured to generate chapter information for setting a chapter in the video data based on selected time stamp information corresponding to a selected face image from the list;
a menu screen data generator configured to generate menu screen data to be used for displaying a menu screen comprising the selected face image as a button based on the chapter information, in such a manner that the button allows a playback apparatus playing back the video to jump to the chapter where the selected face image appears when the button of the selected face image is activated; and
a convertor configured to generate data to be written on an optical disc, the data comprising the video data and the menu screen data.

2. The apparatus of claim 1, wherein the list display processor is configured to adjust the number of the face images in the list within a predetermined number.

3. The apparatus of claim 1, wherein the list display processor is configured to generate the list comprising the face images in time series based on the time stamp information.

4. The apparatus of claim 1 further comprising a grouping module configured to group the face images into groups by determining whether the face images are of a same person,
wherein the list display processor is configured to generate the list comprising the face images to be displayed based on the groups.

5. The apparatus of claim 1, wherein the menu screen data generator is configured to generate the menu screen data in such a manner that face images within a predetermined time slot comprising the time indicated by the time stamp information corresponding to the selected face image are configured to be displayed as a slide show in the button.

6. An authoring method for generating data in an optical disc from video data, the method comprising:
storing a plurality of face images extracted from the video data while the face images are being correlated with time stamp information indicating the times when the face images appear in the video data;
generating a list comprising the face images to be displayed;
generating chapter information for setting a chapter in the video data based on selected time stamp information corresponding to a selected face image from the list;
generating menu screen data to be used for displaying a menu screen comprising the selected face image as a button based on the chapter information, in such a manner that the button allows a playback apparatus playing back the video to jump to the chapter where the selected face image appears when the button of the selected face image is activated; and
generating data to be written on an optical disc, the data comprising the video data and the menu screen data.

7. The method of claim 6, further comprising adjusting the number of the face images in the list within a predetermined number.

8. The method of claim 6, further comprising generating the list comprising the face images in time series based on the time stamp information.

9. The method of claim 6 further comprising:
grouping the face images into groups by determining whether the face images are of a same person; and
generating the list comprising the face images to be displayed based on the groups.

10. The method of claim 6, further comprising generating the menu screen data in such a manner that face images within a predetermined time slot comprising the time indicated by the time stamp information corresponding to the selected face image are displayed as a slide show in the button.

11. A computer readable medium having stored thereon a software program for generating data to be stored in an optical disc from video data that, when executed by a computer, causes the computer to:
store a plurality of face images extracted from the video data while the face images are being correlated with time stamp information indicating the times where the face images appear in the video data;
generate a list comprising the face images to be displayed;
generate chapter information for setting a chapter in the video data based on a selected time stamp information corresponding to a selected face image from the list;
generate menu screen data to be used for displaying a menu screen comprising the selected face image as a button based on the chapter information, in such a manner that the button allows a play back apparatus playing back the video to jump to the chapter where the selected face image appears when the button of the selected face image is activated; and
generate data to be written on an optical disc, the data comprising the video data and the menu screen data.
